(19) United States
(12) Patent Application Publication
(10) Pub. No.: US 2007/0084410 A1
(43) Pub. Date: Apr. 19, 2007

(54) Automobile pad for transporting canines

(76) Inventor: Ronald C. Hain, Elburn, IL (US)

Correspondence Address: THE LAW OFFICE OF RANDALL T. ERICKSON, P.C., 425 WEST WESLEY STREET, SUITE 1, WHEATON, IL, 60187, US

(21) Appl. No.: 11/542,824

(22) Filed: Oct. 4, 2006

Related U.S. Application Data
(60) Provisional application No. 60/723,575, filed on Oct. 4, 2005.

(51) Int. Cl. A01K 1/035

(52) U.S. Cl. 119/28.5

(57) ABSTRACT

A pad for protecting animals transported in vehicles includes a cushioned base portion arranged to be laid flat onto a support surface of the vehicle such that the first portion has a top surface. The pad can also have a cushioned rear portion arranged to be positioned adjacent to the base portion at an angle to the base portion such that the second portion has a front surface. The top and front surfaces are preferably covered by a vinyl covered fabric composite material. The base and rear portions can be contiguously connected along a fold line.

This application claims the benefit of U.S. Provisional Application Ser. No. 60/723,575 filed Oct. 4, 2006.

### TECHNICAL FIELD OF THE INVENTION

The invention relates to cushioned padding for transporting canines in vehicles, boarding kennels, veterinary clinics, and home.

### BACKGROUND OF THE INVENTION

Current public safety vehicles used for transporting canines, such as police cars, are equipped with a kennel system comprised of metal walls, a ceiling and a floor. The floor is generally covered with a one-half inch to one inch thick rubber pad.

During transportation, canines can be subjected to forces and accelerations that cause the canine to impact against the walls or floor of the kennel system. Also, the constant application of forces from variable directions can cause a standing canine to be constantly attempting to compensate so as to not fall within the vehicle. Such forces can cause stress on the canine, and particularly stress on the canine's hips and spine.

The present inventor has recognized that it would be desirable to provide an enhanced stability of the canine in the vehicle, and to provide an enhanced protection from impact of the canine against the rear wall. The present inventor has recognized that it would be desirable to reduce the stress and degeneration of a canine's hips and spine caused by the rigors of continuous transportation in an emergency vehicle. The present inventor has recognized that it would be desirable to provide an impact protection pad for a canine that resists damage from biting and clawing, and is also hypo-allergenic.

### SUMMARY OF THE INVENTION

The present invention provides a protection pad for a vehicle kennel that installs over the heretofore known rubber floor pad and against the rear metal wall. The protection pad increases the stability of the canine in the vehicle by increasing the paw and claw grip of the canine on the protection pad and creates an impact cushion against the rear wall. It is anticipated that the invention will dramatically reduce the stress and degeneration of a canine's hips and spine caused by the rigors of continuous transportation in an emergency vehicle.

The protection pad comprises an outer cover composed of a thick vinyl covered fabric composite such as a Naugahyde® brand material available from Uniroyal Engineered Products, LLC, Naugahyde National Sales Office, of Stoughton, Wis., USA, or a PATRIOT PLUS II brand material available from Spradling International, Inc. of Pelham, Ala., USA. The pad resists damage from biting and clawing, and is hypo-allergenic.

The protection pad is a one piece system that covers the kennel floor and extends up the rear wall of the kennel. Beneath the outer cover is a base cushion and a wall cushion. The base cushion comprises a two inch thick foam pad that extends substantially over the width and length of the floor of the kennel. The wall cushion comprises a one inch thick foam pad that extends substantially along the width and height of the kennel. An impact cushion comprising a one inch thick foam pad is affixed to the wall cushion and extends the width of the wall cushion. The impact cushion covers about one-third of the height of the wall cushion, and is substantially vertically centered on the wall cushion. The impact cushion faces into the kennel and supports the canine during impact against the rear wall. The outer cover and the wall cushion are secured by three to five hooks affixed to a grommet strip of the outer cover and attached to the rear wall of the kennel system.

Preferably these cushions are contained within pockets formed between the outer cover and backing pieces of fabric material beneath the base cushion and wall cushion. The backing pieces can also be composed of vinyl covered fabric. The outer cover of the pad is preferably one continuous, seamless piece of vinyl covered fabric, extending along the base cushion and wall cushion. The outer cover of vinyl covered fabric wraps over the top and sides of the foam and is attached beneath the cushions, particularly to the two separate backing pieces sewn together and to the outer cover.

As a further aspect of the invention, the protection pads can also be used with or without the wall cushion as bedding in boarding kennels, veterinarian clinics, and pet owner's homes. The boarding kennel, veterinary and home use pad can be constructed of the same vinyl covered fabric and foam pad and varied in width and length based on the desired need.

One benefit of the two inch thick base cushion is to allow the canine to depress its paws into the cushion, eliminating sliding. The two inch pad also absorbs shock from vehicle movement. One benefit of the rear wall cushion is to absorb the shock of the canine's collision against the wall. This is found to be the most common point of impact while a canine is traveling in a vehicle. The additional strip of one inch padding creates an added, contoured buffer against rear wall impact.

By use of this specific composite vinyl covered fabric as the outer cover, the protection pad does not retain hair, dander, or soils, making it hypo-allergenic. This material is easily cleaned by application of water and wiping and drying with a cloth.

Numerous other advantages and features of the present invention will be become readily apparent from the following detailed description of the invention and the embodiments thereof, and from the accompanying drawings.

### BRIEF DESCRIPTION OF THE DRAWINGS

FIG. 1 is a fragmentary perspective view showing the protection pad of the present invention installed into a vehicle to protect a canine;

FIG. 2 is a perspective view of the protection pad of the present invention;

FIG. 3 is a side view of the protection pad;

FIG. 4 is a plan view of the protection pad, shown flattened;

FIG. 5 is a sectional view taken generally along line 5-5 of FIG. 4;

FIG. 6 is a plan view of an alternate embodiment protection pad of the present invention, shown flattened;

FIG. 7 is a side view of the protection pad of FIG. 6; and

FIG. 8 is a front view of a further alternate embodiment protection pad of the present invention.

### DETAILED DESCRIPTION OF THE PREFERRED EMBODIMENTS

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

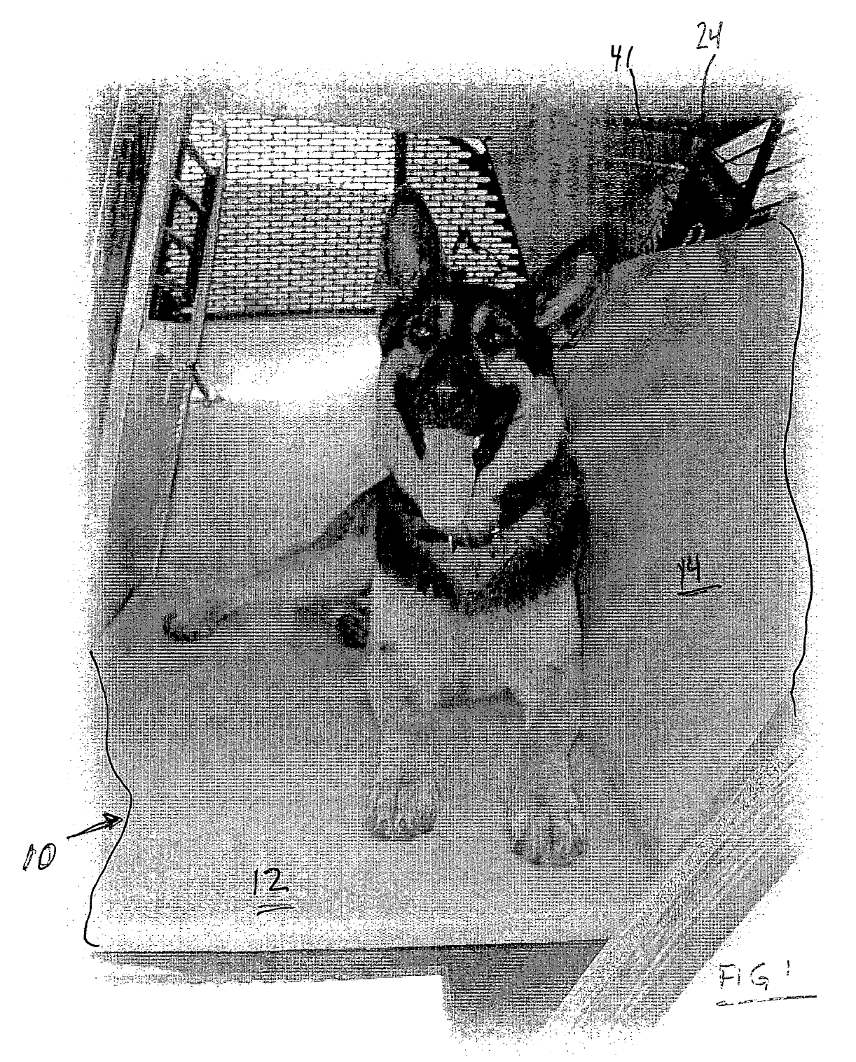

FIG. 1 illustrates a protection pad in accordance with the present invention. The protection pad 10 includes a base portion 12 and a rear portion 14. The base portion 12 is supported on a horizontal surface within a caged area of the automobile, and the rear wall surface 14 is supported in a substantially vertical orientation by being attached to a rear cage wall 24 within the vehicle.

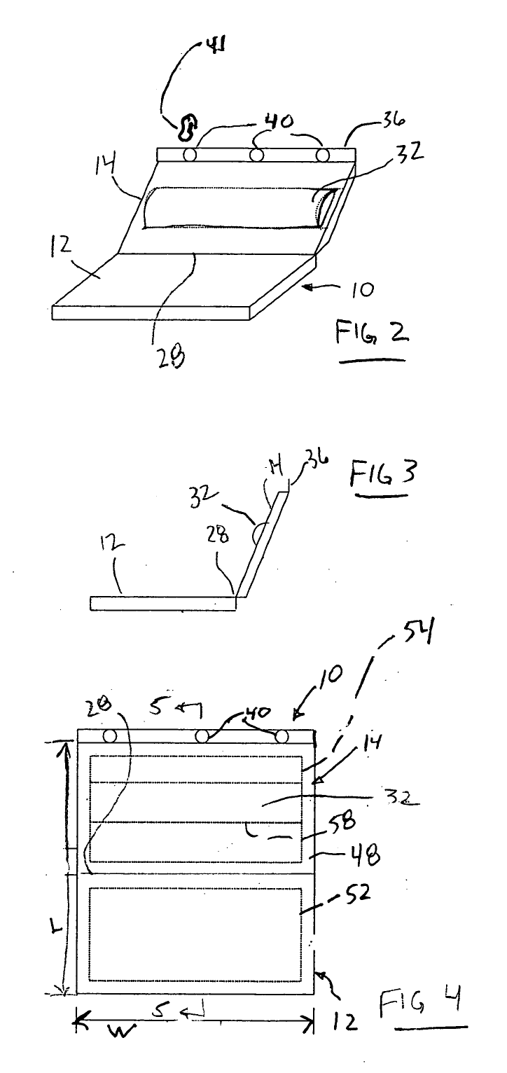

FIG. 2 illustrates the protection pad 10 of the invention in more detail. The base portion 12 is integrated with the rear portion 14 continuously along a fold line 28. The rear portion 14 includes a protruding bumper pad 32 that extends in a vertical direction about one third the total height of the rear portion 14, substantially vertically centered thereon and extends laterally substantial equivalent to the lateral dimension of the rear portion 14. A strip 36 extends above the rear portion 14 and holds a plurality of grommets or reinforcements 40. The grommets 40 are fastened or otherwise attached to the strip 36, and allow for openable chain link connectors or hooks or clasps 41 (one shown) to engage a respective grommet 40 and part of the kennel rear cage wall.

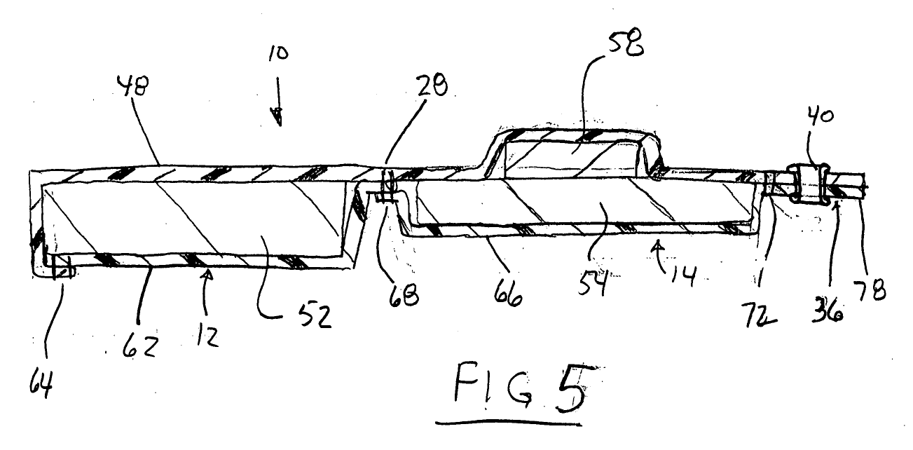

FIG. 4 shows the plan view of the pad 10. The pad 10 comprises a top cover 48 extending throughout a length L of the pad 10 plus an additional length to account for the strip 36, and over a width W. According to the preferred embodiment, the length L is about 54 inches, and the width W is about 48 inches. Beneath the cover 48, a 2 inch thick foam cushion 52 is arranged within the base portion 12. The foam cushion has a preferred lateral dimension of about 46 inches compared to a preferred overall lateral dimension of the pad 10 of about 48 inches, to allow for some clearance to construct the pad. The longitudinal length of the foam cushion 52 can also be smaller than the pad to allow for some clearance to construct the pad.

A foam cushion 54, about 1 inch thick, is also arranged beneath the cover 48, within the rear wall portion 14. The bumper cushion 32 is formed by a further 1 inch foam cushion 58 that is glued to the 1 inch foam cushion 54. The foam cushions 54, 58 also have a lateral dimension of approximately 46 inches. The longitudinal length of the foam cushion 54 can also be smaller than the pad to allow for some clearance to construct the pad.

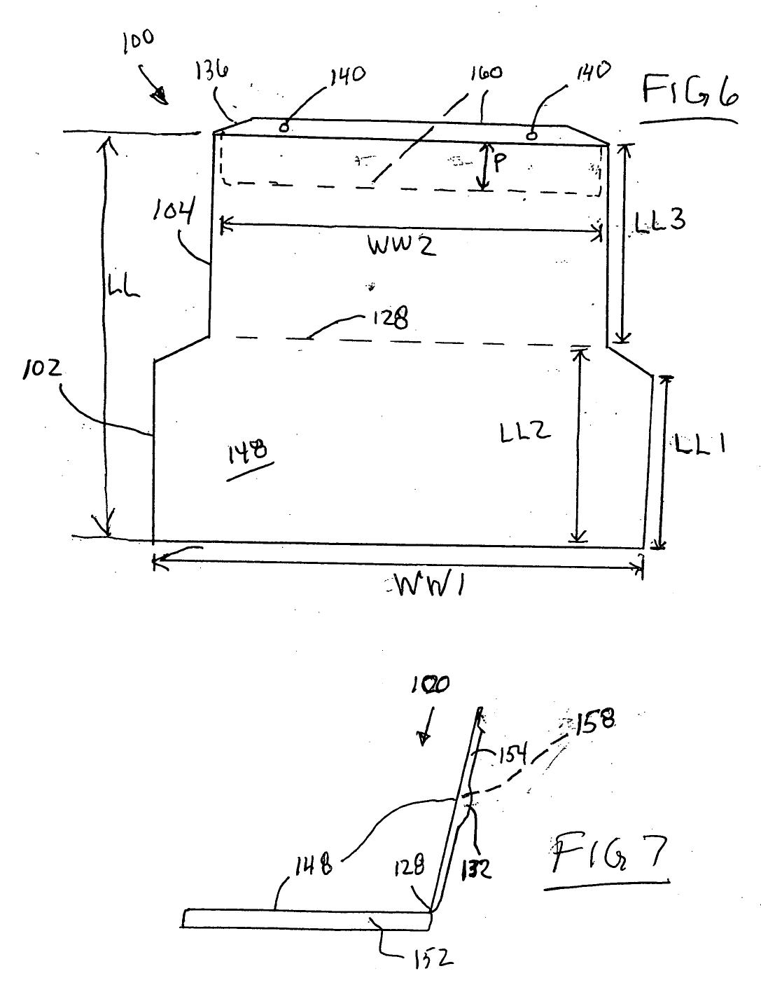

FIG. 5 illustrates the pad 10 is constructed by the cover 48 extending around a backside of the cushion 52 and being secured to a first backing fabric piece 62 at a seam 64, by stitching or the like. A similar arrangement is undertaken on opposite sides of the foam cushion 52 so that the foam pad is entirely enclosed between the cover 48 and the first fabric backing piece 62. Around the fold line 28 the first backing piece 62 is stitched or otherwise connected to the cover 48 and to a second fabric backing piece 66 at a seam 68. The second fabric backing piece 66 and the cover 48 completely enclose the foam cushions 54, 58. The second backing piece 66 is stitched or otherwise connected to the front cover 48 on each opposite side and also at a front seam 72 by stitching or the like.

The cushions 52, 54 have width, thickness and length dimensions to substantially fill the pockets formed between the cover 48 and the backing pieces 62, 66.

The front cover 48 and the second backing piece 66 extend past the seam 72 to form the strip 36 which mounts the grommets 40. The cover 48 and the second backing piece 66 are also stitched or otherwise secured around a perimeter of the strip 36, such as at a front end seam 78.

According to one aspect of the invention, the cover 48 is composed of a material that is advantageous for use with canines, such as composite vinyl covered fabric. The first and second backing pieces 62, 66 can also be composed of the same material as the cover 48. Advantageously, the finished surface or smooth side of the material faces toward the outside of the pad 10.

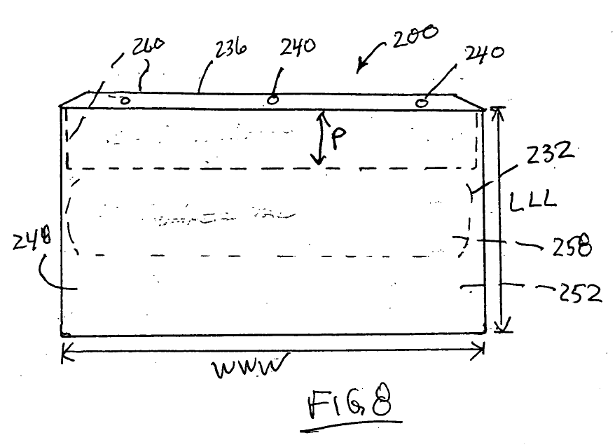

FIGS. 6 and 7 illustrate an alternate embodiment protection pad in accordance with the present invention. The embodiment can have identical features as the first described embodiment except as differentiated herein. The protection pad 100 includes a base portion 102 and a rear portion 104.

In use, the base portion 102 is supported on a horizontal surface within a caged area of the automobile, and the rear wall surface 104 is supported in a substantially vertical orientation by being attached to the rear cage wall 24 within the vehicle.

The base portion 102 is integrated with the rear portion 104 continuously along a fold line 128. The rear portion 104 includes a protruding bumper pad 132 substantially vertically centered thereon and extends laterally substantial equivalent to the lateral dimension of the rear portion 104. A strip 136 extends above the rear portion 104 and holds a plurality of grommets or reinforcements 140. The grommets 140 allow for the openable chain link connectors or hooks or clasps 41 to engage a respective grommet 140 and part of the kennel rear cage wall.

The pad 100 comprises a top cover 148 extending throughout a length LL of the pad 100 and over a width WW. According to the preferred embodiment, the lengths LL1 is about 17 inches, the lengths LL2 is about 27 inches, the lengths LL3 is about 20 inches, the width WW1 is about 56 inches, and the width WW2 is about 43 inches. Beneath the cover 148, a 2 inch thick foam cushion 152 is arranged within the base portion 102. The foam cushion has a preferred lateral dimension of slightly less than overall lateral dimension WW1 of the pad 100, and a longitudinal dimension slightly less than LL2 to allow for some clearance to construct the pad.

A foam cushion 154, about 1 inch thick, is also arranged beneath the cover 148, within the rear wall portion 104. The bumper cushion 132 is formed by a further 1 inch foam cushion 158 that is glued to a back of the 1 inch foam cushion 154. The foam cushions 154, 158 also have a lateral dimension slightly less than the dimension WW2 and the cushion 154 has a longitudinal length slightly less than LL3 to allow for some clearance to construct the pad.

A reinforcing strip 160 of ABS plastic can be integrated with the strip 136, by being covered by, and/or sewn to, the strip 136. The strip 160 preferably extends about 6-8 inches downward in the direction P into the rear portion 104 beneath the cover 148 and over the cushion 154. The grommets 140 can be formed with or otherwise attached to the strip 260. The reinforcing strip 260 increases the durability of the pad.

FIG. 8 illustrates a further alternate embodiment protection pad in accordance with the present invention. The embodiment can have identical features as the first described embodiment except as differentiated herein.

In use, the protection pad 200 is either supported on a horizontal surface within a caged area of the automobile, or is supported in a substantially vertical orientation by being attached to the rear cage wall 24 within the vehicle.

The protection pad 200 can include a protruding bumper pad 232 substantially vertically centered thereon and extends laterally substantial equivalent to the lateral dimension of the protection pad 200. A strip 236 extends above the protection pad 200 and holds a plurality of grommets or reinforcements 240. The grommets 240 are formed with or otherwise attached to the strip 236, and allow for the openable chain link connectors or hooks or clasps 41 to engage a respective grommet 240 and part of the kennel rear cage wall.

The pad 200 comprises a top cover 248 extending throughout a length LLL of the pad 100 and over a width WWW. According to the preferred embodiment, the length LLL is about 20 to 30 inches or as desired, and the width WWW is about 48 inches. Beneath the cover 248, a 1 or 2 inch thick foam cushion 252 is arranged within the protection pad 200. The bumper cushion 232 is formed by a further 1 inch foam cushion 258 that is glued to the foam cushion 252. The foam cushions 252, 258 have dimensions of slightly less than the dimensions LLL and WWW to allow for some clearance to construct the pad.

A reinforcing strip 260 of ABS plastic can be integrated with the strip 236, by being covered by, and/or sewn to, the strip 236. The strip 260 preferably extends about 6-8 inches in the direction P into the pad 200 beneath the cover 248 and over the cushion 252. The grommets 240 can be formed with or otherwise attached to the strip 260. The reinforcing strip 260 increases the durability of the pad.

As with the first embodiment, the covers 148, 248 are composed of a material that is advantageous for use with canines, such as composite vinyl covered fabric. The strips and grommets are advantageously composed of ABS plastic. Advantageously, the finished surface or smooth side of the material faces toward the outside of the pads 100, 200.

Another aspect of the invention is that the pads 10, 100 and 200 can be used in selected combinations or alone to cover an entire inside surface of a kennel system or just certain surfaces such as the floor or back surface.

From the foregoing, it will be observed that numerous variations and modifications may be effected without departing from the spirit and scope of the invention. It is to be understood that no limitation with respect to the specific apparatus illustrated herein is intended or should be inferred.

The invention claimed is:

1. A pad for protecting animals transported in vehicles, comprising:
a first portion arranged to be laid flat onto a support surface of said vehicle such that said first portion has a top surface, wherein said first portion comprises a first foam cushion covered on at least said top surface by a first cover portion composed of a vinyl covered fabric composite.

2. The pad according to claim 1, further comprising a second portion arranged to be positioned adjacent to said first portion at an angle to said first portion such that said second portion has a front surface.

3. The pad according to claim 2, wherein said second portion comprises a second foam cushion covered on at least said front surface by a second cover portion composed of a vinyl covered fabric composite.

4. The pad according to claim 3, wherein said first portion and said second portion are contiguously connected along a fold line.

5. The pad according to claim 1, wherein said first portion comprises connecting devices for connecting a top edge portion thereof to an external structure.

6. The pad according to claim 5, wherein said connecting devices comprise reinforced holes passing through said first portion.

7. The pad according to claim 6, wherein said connecting devices comprise clasps, hooks or openable chain link connectors.

8. The pad according to claim 1, wherein said first portion comprises a protruding bumper pad extending transversely across said front surface.

9. A pad for protecting animals transported in vehicles, comprising:
a base portion arranged to be laid flat on a support surface of the vehicle such that said base portion has a top surface; and
a rear portion arranged to be positioned adjacent to said base portion at an angle to said base portion such that said rear portion has a front surface;
wherein said rear portion comprises a protruding bumper pad extending transversely across said rear portion and substantially flat surface areas above and below said protruding bumper pad.

10. The pad according to claim 9, wherein said base portion and said rear portion each comprise a foam cushion covered on at least said top surface and said front surface respectively by a cover composed of a vinyl covered fabric composite.

11. The pad according to claim 10, wherein said base portion and said rear portion are contiguously connected along a fold line.

12. The pad according to claim 11, wherein said rear portion comprises connecting devices for connecting a top edge portion thereof to an external structure in order to hold said rear portion at said angle.

13. A system for protecting canines during transport in vehicles, comprising:
a pad having a base portion arranged to be laid flat on a substantially horizontal support surface of said vehicle such that said base portion has a top surface, and a rear portion arranged to be positioned adjacent to said base portion at an angle to said base portion such that said rear portion has a front surface and a rear surface placed against a substantially vertical structure of said vehicle, said base portion comprising a first foam cushion covered on at least said top surface by a first cover portion composed of a vinyl covered fabric composite.

14. The system according to claim 13, wherein said rear portion comprises a second foam cushion covered on at least said front surface by a second cover portion composed of a vinyl covered fabric composite.

15. The system according to claim 14, wherein said base portion and said rear portion are contiguously connected along a fold line.

16. The system according to claim 13, wherein said rear portion comprises connecting devices for connecting a top edge portion thereof to said substantially vertical structure in order to hold said rear portion at said angle.

17. The system according to claim 13, wherein said rear portion comprises a protruding bumper pad extending transversely across said rear portion and substantially flat surface areas above and below said protruding bumper pad.

18. The system according to claim 13 wherein said substantially horizontal support surface is provided by a cargo floor of a rear cargo area of said vehicle and said substantially vertical structure comprises said back wall of said rear cargo area.
